(19) United States
(12) Patent Application Publication
(10) Pub. No.: US 2017/0011388 A1
(43) Pub. Date: Jan. 12, 2017

(54) CARDS, COMPONENT MODULES, MANUAL INPUT DEVICES, DYNAMIC SECURITY CODES AND METHODS OF FORMING ELECRONIC CARDS

(71) Applicant: Dynamics Inc., Cheswick, PA (US)

(72) Inventors: Jeffrey D. Mullen, Glenshaw, PA (US); Norman E. O'Shea, Seven Fields, PA (US); Allen D. Bowers, Aspenwall, PA (US); Andrew Veter, Pittsburgh, PA (US)

(21) Appl. No.: 15/153,446

(22) Filed: May 12, 2016

Related U.S. Application Data
(60) Provisional application No. 62/189,740, filed on Jul. 7, 2015.

(51) Int. Cl. G06Q 20/34; G06K 7/08; G06K 7/10; G06F 3/14

(52) U.S. Cl. CPC G06Q 20/356; G06F 3/14; G06K 7/082; G06K 7/10297

(57) ABSTRACT

A device comprising a battery, a display operable to display information, a display controller operable to control the display; and a toggle button operable to communicate with the display controller to change the information displayed on the display.

### CROSS-REFERENCE TO RELATED APPLICATION

This application claims the benefit of U.S. Provisional Patent Application No. 62/189,740, titled “CARDS, COMPONENT MODULES, MANUAL INPUT DEVICES, DYNAMIC SECURITY CODES AND METHODS OF FORMING ELECRONIC CARDS,” filed Jul. 7, 2015 (Attorney Docket No. D/153PROV), which is hereby incorporated by reference herein in its entirety.

### BACKGROUND OF THE INVENTION

Example embodiments relate to devices and transaction systems. For example, electronic cards including component modules and financial transaction systems using dynamic security codes.

### SUMMARY OF THE INVENTION

Two or more polymer layers may be fused together on a lamination machine. Card blanks may be punched from the fused layers. A portion of one surface of the card blank may be removed using a milling machine to form a recessed region including a deep recessed region and a shallow recessed region. The deep recessed region may correspond to the thickness of a component module including one or more components and a reel-to-reel substrate. The shallow recessed region may correspond to a thickness of the reel-to-reel substrate. A component module may be embedded using a reel to reel device by cutting the component module from the reel-to-reel tape and placing the component module into the recessed region. The component module may be adhered using an adhesive or a bonding process, such that the surface of the processor is about even with the surface of the card blank material. The module may be adhered prior to cutting or may be severed from the reel-to-reel tape during the adhesion process. For example, a tape section, including a display, a battery, a memory, a manual input device and a second processor, may be cut from a roll and laid over the recess, the size of the tape section corresponding to the size of the recess, such that components (e.g., a display, battery and processor) including the tape are positioned in the deep recess region, and the tape is positioned in the shallow recess region. Heat and/or pressure is applied to the surface of the card including the tape to fuse the tape to the card to form a card assembly. The card assembly is personalized by printing and/or data transfer to each processor to form a customer card. The card body may be personalized prior to the addition of the component module.

### BRIEF DESCRIPTION OF THE DRAWINGS

Principles and advantages of the present invention can be more clearly understood from the following detailed description considered in conjunction with the following drawings, in which the same reference numerals denote the same structural elements throughout, and in which:

FIG. 1 shows component modules constructed in accordance with the principles of the present invention;

FIG. 2 shows devices constructed in accordance with the principles of the present invention;

FIG. 3 shows assembly units in accordance with the principles of the present invention; and

FIG. 4 shows assembly units in accordance with the principles of the present invention.

### DETAILED DESCRIPTION OF THE INVENTION

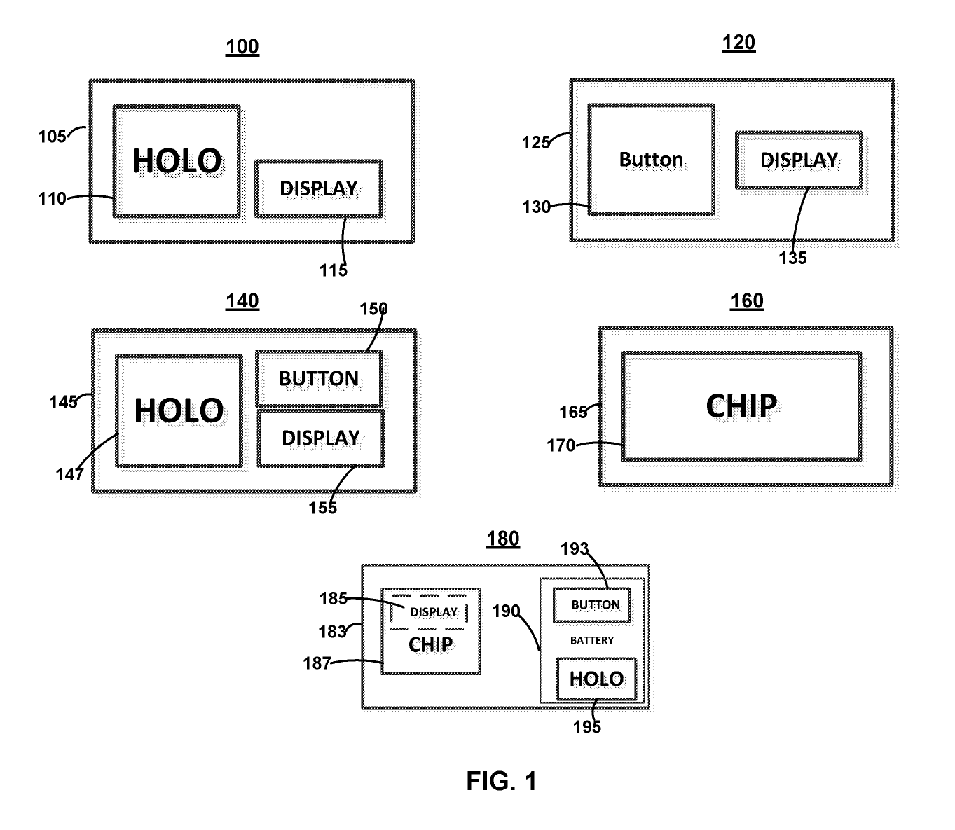

FIG. 1 shows component modules constructed in accordance with the principles of the present invention. FIG. 1 shows example component modules 100, 120, 140, 160 and 180.

Referring to FIG. 1, component module 100 may include, for example, substrate 105, display 110 and display 115. Substrate 105 may include, for example, organic, materials, inorganic materials and combinations thereof. For example, substrate 105 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 105 may be flexible, partially flexible, or rigid. Substrate 105 may be transparent, partially transparent or opaque. Substrate 105 may be a printed circuit board (PCB) connecting components of component module 100 to one or more external devices. According to some example embodiments, substrate 105 may be biodegradable. According to some example embodiments, substrate 105 may be a feed substrate, for example, a substrate compatible with reel-to-reel device.

Displays 110 and 115 may static or dynamic displays. For example, each of display 110 and display 115 may be an electrophoretic display (e.g., e-ink), an LCD display, an LED display, a hybrid display, a photograph, a hologram and/or the like. Display 110 and/or display 115 may be a haptic display, a contact responsive display (e.g., touch responsive) and/or a light responsive display. Display 110 may be the same type of display as display 115, or a different type of display.

Substrate 105, display 110 and display 115 may be arranged in component module 100 in correspondence to features of a partially formed device (not shown). For example, the partially formed device may include one or more spaces for display 110, display 115 and/or substrate 105. Substrate 105, display 110 and display 115 may be arranged to fit into the spaces of the partially formed device such that substrate 105, display 110 and/or display 115 complete the partially formed device or complete a portion of the partially formed device.

Substrate 105, display 110 and/or display 115 may, for example, complete or partially complete one or more surfaces of the partially formed device, before or after further processing operations. For example, material may be placed over a portion or all of component module 100 to complete the partially formed device, for example, one or more layers of protective material or graphics material.

According to some example embodiments, substrate 105 may be transparent and complete a surface of the partially formed device, or a portion of the surface of the partially formed device, such that display 115 and/or display 110 is visible through substrate 105. According to some example embodiments, display 110 and display 115 may be embedded in substrate 105 such that a surface of substrate 105, a surface of display 110 and a surface of display 115 complete or partially complete a surface of the partially formed device. According to some example embodiments, the one or more spaces of the partially formed device may be a single recessed region of varying depth. At least a part of the recessed portion may include one or more through-device vias, and, for example, display 115 and/or display 110 may pass through the partially formed device. A surface of substrate 105 may complete or partially complete a surface of the partially formed device through which component module 120 is inserted, and a surface of display 115 and/or a surface of display 110 may complete or partially complete a surface of the device other than the insertion surface.

According to some example embodiments, a visual display of one of displays 110 and 115 may be visible from one side of the device and a visual display of the other of displays 110 and 115 may be visible from the opposite side.

According to at least one example embodiment, substrate 105 may be a detachable substrate used to insert display 110 and display 115 into the one or more spaces.

Component module 120 may include, for example, substrate 125, manual input device 130 and display 135. Substrate 125 may include, for example, organic, materials, inorganic materials and combinations thereof. For example, substrate 125 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 125 may be flexible, partially flexible, or rigid. Substrate 125 may be transparent, partially transparent or opaque. According to some example embodiments, substrate 125 may be biodegradable. Substrate 105 may be a printed circuit board (PCB) connecting components of component module 100 and/or connecting component module 110 to one or more external devices. According to some example embodiments, substrate 125 may be a feed substrate, for example, a substrate compatible with reel-to-reel device.

Manual input device 130 may be, for example, a mechanical button, a sensor (e.g., a touch sensor), an accelerometer, a piezoelectric switch, gyroscopic, a pair of contacts or combinations thereof. For example, manual input device 130 may be a pair of contacts connected to a circuit. The circuit may be completed by an object (e.g., a finger and/or a stylus) bridging the contacts, for example, to electrically connect the contacts.

Display 135 may be a static or dynamic display. For example, display 130 may be an electrophoretic display (e.g., e-ink), an LCD display, an LED display, a hybrid display, a photograph, a hologram and/or the like. Display 130 may be a haptic display, a contact responsive display (e.g., touch responsive) and/or a light responsive display.

Substrate 125, manual input device 130 and display 135 may be arranged in component module 120 in correspondence to features of a partially formed device (not shown). For example, the partially formed device may include one or more spaces for manual input device 130, display 135 and/or substrate 125. Substrate 125, manual input device 130 and display 135 may be arranged to fit into the spaces of the partially formed device such that substrate 125, display 135 and/or manual input device 130 complete the partially formed device or complete a portion of the partially formed device.

Substrate 125, manual input device 130 and/or display 135 may, for example, complete or partially complete one or more surfaces of the partially formed device, before or after further assembly operations. According to some example embodiments, material may be placed over a portion or all of component module 120 to complete the partially formed device, for example, one or more layers of protective material or graphics material.

According to some example embodiments, substrate 125 may be transparent, and complete or partially complete a surface of the device such that display 135 and/or manual input device 130 is visible through substrate 125. According to some example embodiments, manual input device 130 and display 135 may be embedded in substrate 125 such that a surface of substrate 125, a surface of manual input device 130 and a surface of display 135 complete or partially complete a surface of the partially formed device. According to some example embodiments, the one or more spaces of the partially formed device may be a single recessed region of varying depth. At least a part of the recessed region may include one or more through-device vias, and, for example, display 135 and/or manual input device 130 may pass through the partially formed device. A surface of substrate 125 may complete or partially complete a surface of the partially formed device through which component module 120 is inserted, and a surface of display 135 and/or a surface of manual input device 130 may complete or partially complete a surface of the device other than the insertion surface.

According to some example embodiments, a visual display of display 135 may be visible from one side of the device and a surface of manual input device 130 may be visible from the opposite side. According to at least one example embodiment, substrate 125 may be a detachable substrate used to insert manual input device 130 and display 135 into the one or more spaces.

Component module 140 may include, for example, substrate 145, manual input device 150, and displays 147 and 155. Substrate 145 may include, for example, organic, materials, inorganic materials and combinations thereof. For example, substrate 145 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 145 may be flexible, partially flexible, or rigid. Substrate 145 may be transparent, partially transparent or opaque. Substrate 105 may be a printed circuit board (PCB) connecting components of component module 100 and/or connecting component module 110 to one or more external devices. According to some example embodiments, substrate 145 may be biodegradable. According to some example embodiments, substrate 145 may be a feed substrate, for example, a substrate compatible with reel-to-reel device.

Manual input device 150 may be, for example, a mechanical button, a sensor (e.g., a touch sensor), an accelerometer, a piezoelectric switch, gyroscopic, a pair of contacts or combinations thereof. For example, manual input device 150 may be a pair of contacts connected to a circuit. The circuit may be completed by an object (e.g., a finger and/or a stylus) bridging the contacts, for example, to electrically connect the contacts.

Displays 147 and 155 may static or dynamic displays. For example, each of displays 147 and 155 may be an electrophoretic display (e.g., e-ink), an LCD display, an LED display, a hybrid display, a photograph, a hologram and/or the like. Display 147 and/or display 155 may be a haptic display, a contact responsive display (e.g., touch responsive) and/or a light responsive display. Display 147 may be the same type of display as display 155, or a different type of display.

Substrate 145, manual input device 150, display 147 and display 155 may be arranged in component module 120 in correspondence to features of a partially formed device (not shown). For example, the partially formed device may include one or more spaces for manual input device 150, display 147, display 155 and/or substrate 145. Substrate 145, manual input device 150, display 147 and display 155 may be arranged in component module 140 to fit into the spaces of the partially formed device such that substrate 145, display 147, display 155 and/or manual input device 150 complete the partially formed device or complete a portion of the partially formed device.

Substrate 145, manual input device 150, display 147 and/or display 155 may, for example, complete or partially complete one or more surfaces of the partially formed device, before or after further assembly operations. According to some example embodiments, material may be placed over a portion or all of component module 140 to complete the partially formed device, for example, one or more layers of protective material or graphics material.

According to some example embodiments, substrate 145 may be transparent and complete or partially complete a surface of the device such that one or more of display 147, display 155 and/or manual input device 150 is visible through substrate 145. According to some example embodiments, one or more of manual input device 150, display 147 and display 155 may be embedded in substrate 145 (e.g., an opaque substrate) such that one or more of a surface of substrate 145, a surface of manual input device 150, a surface of display 147 and a surface of display 155 complete or partially complete a surface of the partially formed device. According to some example embodiments, the one or more spaces of the partially formed device may be a single recessed region of varying depth. At least a part of the recessed region may include one or more through-device via, and, for example, display 147, display 155 and/or manual input device 150 may pass through the partially formed device. A surface of substrate 145 may complete or partially complete a surface of the partially formed device through which component module 140 is inserted, and one or more of a surface of display 147, a surface of display 155 and a surface of manual input device 150 may complete or partially complete a surface of the device opposite from the insertion surface.

According to some example embodiments, a visual display of display 147, a visual display of display 155, and a surface of manual input device 150 may be visible from different sides of the device according to the arrangement of component module 140 (e.g., a transparent substrate, or an embedded substrate and a recessed region with through-device vias). As one example, a visual display of display 147 and a surface of manual input device 150 may be visible from one side of the device, and a visual display of display 155 may be visible from the opposite side of the device.

According to at least one example embodiment, substrate 145 may be a detachable substrate used to insert manual input device 150 and displays 147 and 155 into the one or more spaces.

Component module 160 may include, for example, substrate 165 and integrated circuit (IC) chip 170. Substrate 165 may include, for example, organic, materials, inorganic materials and combinations thereof. For example, substrate 165 may be a polymer substrate (e.g., PVC, PVCA, PET, PETE and/or the like), a metal substrate (e.g., titanium), a carbon substrate, a composite substrate (e.g., FR-4) and/or a ceramic substrate. Substrate 165 may be flexible, partially flexible, or rigid. Substrate 165 may be transparent, partially transparent or opaque. Substrate 165 may be a printed circuit board (PCB) connecting components of component module 100 and/or connecting component module 110 to one or more external devices. According to some example embodiments, substrate 165 may be biodegradable. According to some example embodiments, substrate 165 may be a feed substrate, for example, a substrate compatible with reel-to-reel device.

IC chip 170 may be, for example, a processor, an application specific integrated circuit (ASIC) and/or a memory. According to some example embodiments, IC chip 170 may be an EMV chip (e.g., an EMV compliant processor).

Substrate 165 and IC chip 170 may be arranged in component module 160 in correspondence to features of a partially formed device (not shown). For example, the partially formed device may include one or more spaces for substrate 165 and/or IC chip 170. Substrate 165 and IC chip 170 may be arranged to fit into the spaces of the partially formed device such that substrate 165 and/or IC chip 170 complete the partially formed device or complete a portion of the partially formed device.

Substrate 165 and IC chip 170 may, for example, complete or partially complete one or more surfaces of the partially formed device, before or after further assembly operations. According to some example embodiments, material may be placed over all or a portion of substrate 165, and over a portion IC chip 170, to complete the partially formed device, for example, one or more layers of protective material or graphics material.

According to some example embodiments, IC chip 170 may be embedded in substrate 165 such that IC chip 170 penetrates through substrate 165 or is exposed as a portion of a recess of substrate 165. One or more surfaces of IC chip 170 may be contiguous with a surface of substrate 165. According to some example embodiments, the one or more spaces of the partially formed device may be a single recessed region of varying depth. At least a part of the recessed region may include a through-device via, and, for example, IC chip 170 may be adhered to substrate 165 and pass through the partially formed device. A surface of substrate 165 may complete or partially complete a surface of the partially formed device through which component module 160 is inserted, and a surface of IC chip 170 may complete or partially complete a surface of the device other than the insertion surface.

According to at least one example embodiment, substrate 165 may be a detachable substrate used to insert IC chip 170 into the one or more spaces.

Component module 180 may include, for example, substrate 183, display 185, IC chip 187, manual input device 193, power supply 190 and display 195. Substrate 183, display 185, IC chip 187, manual input device 193, and display 195 may be arranged as a variation of the arrangements disclosed above.

Power supply 190 may include, for example, a battery, RF harvesting device, and/or a power regulating device. As shown using a dashed box, display 185 may be stacked underneath IC chip 187. Similarly, power supply 190 may be stacked with manual input device 193 and display 195. IC chip 187 may be, for example, embedded in substrate 183, on an opposite side of substrate 183 from display 185, or stacked with display 185 on one side of substrate 183. Display 185 may be, for example, embedded in substrate 183, on an opposite side of substrate 183 from IC chip 187, or stacked with IC chip 187 on one side of substrate 183. Manual input device 193 and display 195 may be, for example, embedded in substrate 183, on an opposite side of substrate 183 from power supply 190 or stacked with power supply 190 on one side of substrate 183.

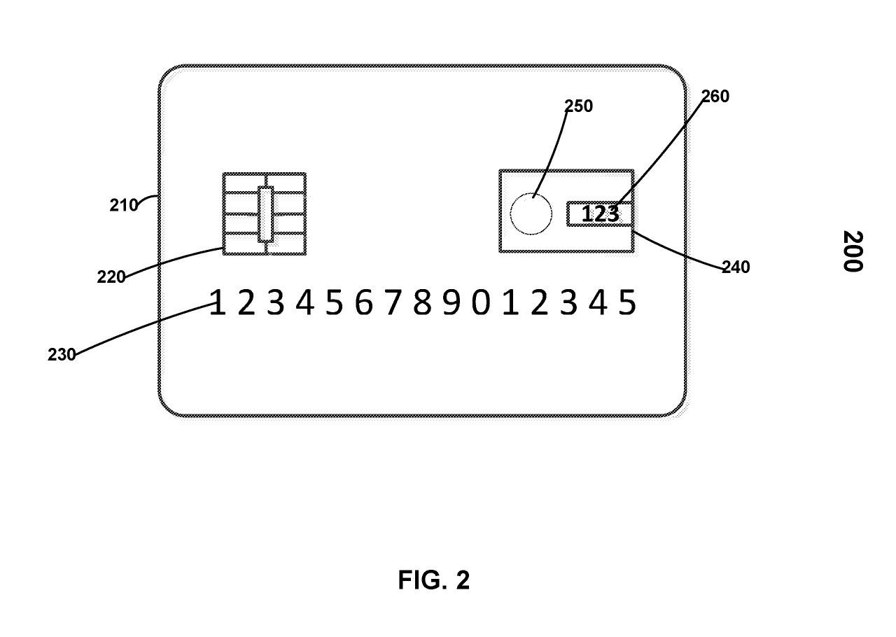

FIG. 2 shows devices constructed in accordance with the principles of the present invention. Referring to FIG. 2, device 200 may be, for example, an electronic card including substrate 210, processor 220, display 230 and component module 240. Substrate 210 may include, for example, one or more polymer layers. According to at least one example embodiment, substrate 210 may include conductive traces. Processor 220 may be, for example, an EMV chip. Display 230 may be, for example, information printed on substrate 210. Component module 240 may include button 250 and display 260. Button 250 may be, for example, a mechanical dome button. Display 260 may be, for example, an electrophoretic, bi-stable display.

A portion of component module 240 not including button 250 and display 260 may be a component module substrate. The component module substrate may, for example, fill portions of a recess in substrate 210 not occupied by button 250 and display 260.

According to some example embodiments, the component module substrate may be one or more polymer layers. According to other example embodiments, the component module substrate may include conductive traces. The conductive traces of the component module substrate may connect button 250 and display 260. According to at least one example embodiment, the conductive traces of the component module substrate connect button 250 and display 260, and connect to conductive traces of substrate 210 and/or to devices outside of component module 240 (e.g., a battery and/or processor 220). For example, the component module substrate and substrate 210 may be interconnected, flexible printed circuit boards.

The component module substrate may be fixed within a recess of substrate 210, for example, by an adhesive and/or as a result of a bonding process (e.g., using localized heat and pressure to fuse the component module substrate to substrate 210).

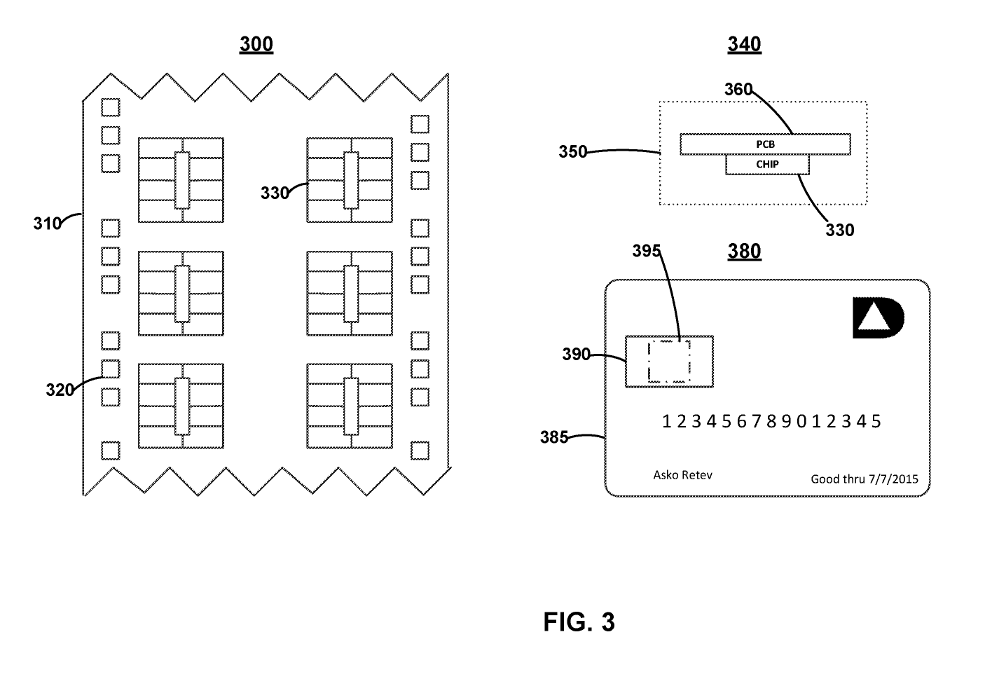

FIG. 3 shows assembly units 300, 340 and 380 in accordance with the principles of the present invention. Assembly unit 300 shows a portion of reel-to-reel tape 310 including sprocket holes 320 and an integrated circuit (IC) chip 330 (e.g., an EMV chip).

Assembly unit 340 shows a cross-section of a component module 350. Component module 350 may include, for example, a portion of reel-to-reel tape 330 including a printed circuit board (PCB) 360 and IC chip 330. PCB 360 may extend outside the footprint of IC chip 330. According to some example embodiments, IC chip 330 is fixed to a surface of PCB 360. According to at least one example embodiment IC chip 330 may extend through PCB 360 such that a surface of PCB 360 and a surface of IC chip 330 are contiguous or roughly contiguous.

Assembly unit 385 shows a personalized financial card body 385. Card body 385 includes a recessed region 390. Recessed region 390 includes deep recessed region 395. A depth into card body 385 of deep recessed region 395 is greater than a depth of portions of recessed region 390 outside of deep recessed region 395. The depth of deep recessed region 395 may correspond to, for example, a thickness of PCB 360 and IC chip 330, and/or deep recessed region may be a through-device via extending through card body 385. A depth of portions of recessed region 390 outside of deep recessed region 395 may correspond to, for example, a thickness of PCB 360.

According to some example embodiments, a thickness of PCB 360 is greater than a depth of portions of recessed region 390 outside of deep recessed region 395 by an amount of thickness lost during a bonding process used to bond component module 350 to card body 385. According to some example embodiments, a thickness of PCB 360 is less than a depth of portions of recessed region 390 outside of deep recessed region 395 by an amount of thickness contributed by an adhesive used to bond component module 350 to card body 385. According to at least one example embodiment, a thickness of PCB 360 is about the same as a depth of portions of recessed region 390 outside of deep recessed region 395.

Component module 350 may be positioned in recessed region 390 such that a surface of IC chip 370 is contiguous with the depicted surface of card body 385 after assembly and/or a surface of IC chip 370 may be contiguous with the opposite side of card body 385 (not shown). According to at least one example embodiment, IC chip 370 includes contact pads on both major surfaces and contact pads are exposed on both sides of card body 385.

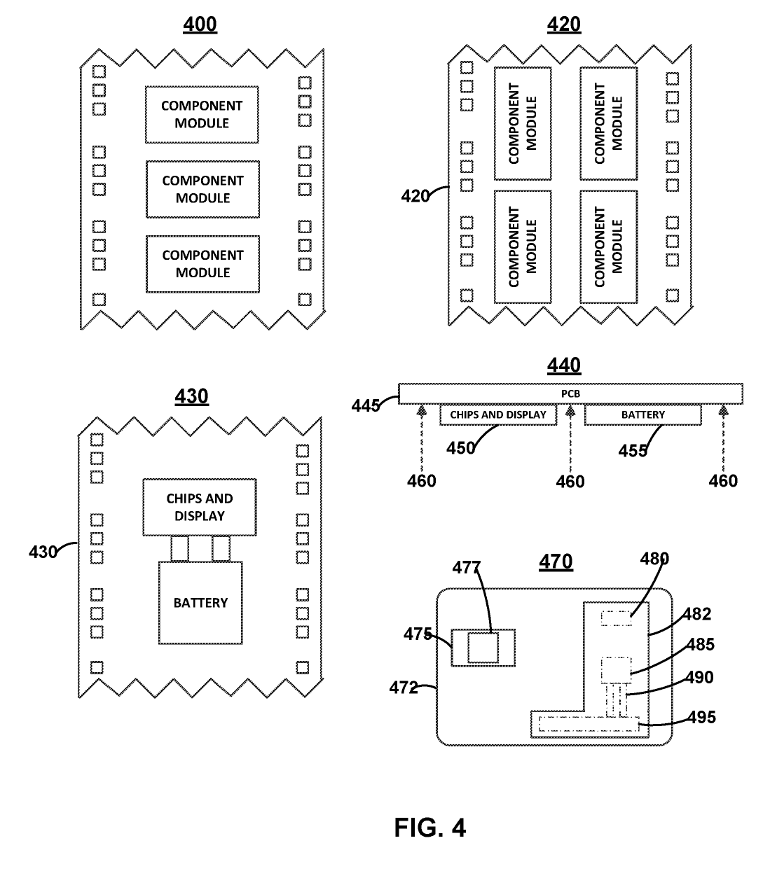

FIG. 4 shows assembly units 400, 420, 430 440 AND 470 in accordance with the principles of the present invention.

What is claimed is:

1. A device comprising:
a battery;
a display operable to display information;
a display controller operable to control the display; and
a toggle button operable to communicate with the display controller to change the information displayed on the display.

2. The device of claim 1, further comprising memory operable to store a first information and a second information.

3. The device of claim 1, further comprising a communication device.

4. The device of claim 1, further comprising a dynamic magnetic communication stripe.

5. The device of claim 1, further comprising a wireless communication device.

6. The device of claim 1, further comprising an RFID.

7. The device of claim 1, further comprising an IC chip.

8. The device of claim 1, wherein data communicated by a communication device is associated with the information displayed on the display.

9. The device of claim 1, wherein the toggle button is operable to cause the display controller to replace a first information on the display with a second information upon activation of the toggle button.

10. The device of claim 1, wherein the toggle button is operable to cause the display controller to replace a first information on the display with a second information upon a first type of activation of the toggle button and operable to cause the display controller to replace a first information on the display with a third information upon a second type of activation of the toggle button.

11. The device of claim 1, wherein the toggle button is operable to cause the display controller to replace a first information on the display with a second information upon activation of the toggle button wherein the first and second information are related.

12. The device of claim 1, wherein the toggle button is operable to cause the display controller to replace a first information on the display with a second information upon activation of the toggle button wherein the first and second information are related to different payment cards.

13. A device comprising:
a token creation module operable to create a token; and
a payment communication device operable to communicate the token to an external device.

14. The device of claim 13, wherein the token creation module is operable to retrieve the token from memory.

15. The device of claim 13, wherein the token creation module is operable to generate the token in response to a request.

16. The device of claim 13, further comprising a reader detection module operable to determine a type of reader.

17. The device of claim 13, wherein the token creation module is operable to create a token based on a type of reader detected.
